(19) United States
(12) Patent Application Publication
(10) Pub. No.: US 2026/0109889 A1
(43) Pub. Date: Apr. 23, 2026

(54) DYNAMIC POLYURETHANE ADHESIVES

(71) Applicant: Northwestern University, Evanston, IL (US)

(72) Inventors: Lillian Margaret Felsenthal, Evanston, IL (US); William Robert Dichtel, Evanston, IL (US)

(21) Appl. No.: 19/338,999

(22) Filed: Sep. 24, 2025

Related U.S. Application Data
(60) Provisional application No. 63/698,556, filed on Sep. 24, 2024.

(51) Int. Cl. C09J 175/08; C08G 18/22; C09J 5/06; C09J 7/30

(52) U.S. Cl. CPC C09J 175/08; C08G 18/222; C09J 5/06; C09J 7/30; C08G 2170/00; C09J 2301/304; C09J 2301/408; C09J 2301/502; C09J 2400/143; C09J 2475/00

(57) ABSTRACT

The present disclosure provides an article including an adherend and a polyurethane adhesive including a carbamate exchange catalyst adhered thereon, wherein the polyurethane adhesive is configured to retain adhesive strength over one or more healing cycles.

### CROSS-REFERENCE TO RELATED APPLICATIONS

The present application claims benefit of priority to U.S. Application Ser. No. 63/698,556, filed Sep. 24, 2024, the contents of which is incorporated by reference in its entirety.

### STATEMENT REGARDING FEDERALLY SPONSORED RESEARCH OR DEVELOPMENT

This invention was made with government support under grant number 1901635 awarded by the National Science Foundation and grant number DE-EE0007897 awarded by the Department of Energy. The government has certain rights in the invention.

### BACKGROUND

Structural adhesives play a crucial role in everyday life to bond joints in automotive, textile, construction, household, and other settings.¹⁻³ These adhesives require high strength and durability, and polymers such as urethane, acrylic, epoxy, phenolic, silicone are commonly employed.^{3, 4} Polyurethanes (PUs) are highly tunable, allowing for specific properties to be matched for both industrial and household applications.^{2, 5-10} Hot melt adhesives, comprised of thermoplastic polymers, provide ease of handling and reprocessability but lack the high tensile strength needed for structural bonding.^{3, 11} Conversely, thermoset adhesives are typically cured directly on the adherends, providing enhanced strength.^{1, 3} However, due to their crosslinked structure, recycling and reuse of thermoset adhesives are not possible.

Covalent adaptable networks (CANs) bridge this gap in reprocessing between thermoplastics and thermosets by employing dynamic crosslinks.¹²⁻¹⁴ Under working conditions, the crosslinks are static, providing mechanical strength and durability to the network. When a stimulus is applied, usually heat, the crosslinks become dynamic, allowing for bond exchange to occur and imparting reprocessability to thermoset networks.^{13, 14} Many dynamic chemistries have been employed in CANs, including thiourethanes, disulfides, boronic esters, Diels-Alder adducts, esters, imines, and siloxanes among many more.^{9, 12, 13, 15-25} However, many of these CANs are designer networks that are not currently produced on industrial scales. Polyurethanes, on the other hand, are among the most produced polymers worldwide, with over 18 million tons being manufactured in 2019.^{26, 27} Our group previously reported the ability to convert PU to CANs via the addition of a carbamate exchange catalyst.²⁸⁻³⁰ We first used organotin compounds as carbamate exchange catalysts, which are bioaccumulative and toxic.³¹ Recently, Sun and coworkers identified environmentally benign and non-toxic zirconium-based carbamate exchange catalysts that provide improved reprocessability to PU CANs without compromising their mechanical properties.³² In particular, zirconium tetrakis(2,2,6,6-tetramethyl-3,5-heptanedionate) [Zr(tmhd)₄] displayed rapid stress relaxation at loadings as low as 0.5 wt % zirconium. A more recent study by Kim et al. elucidated the mechanism of zirconium-based carbamate exchange catalysts and discovered that the zirconium complex coordinates alcohols to promote carbamate bond exchange in PU networks.³³

Bond exchange in CANs is thought to occur between crosslinks within the network.¹³ However, if a substrate is introduced with compatible surface functional groups, bond exchange will occur between the network and substrate. This provides enhanced adhesion through covalent bonding, as well as improved surface wettability.¹⁶ The reversibility of the dynamic covalent bonds also impart self-healing properties to the adhesive and allow for traditional CANs reprocessing.^{15, 16} While adhesive CANs have been demonstrated with a variety of linkages, including thiourethanes, disulfides, boronic esters, and oxime-carbamates, these are not currently used on industrial scales.^{11, 15, 16, 18, 34}

### BRIEF SUMMARY OF THE INVENTION

The disclosure provides an article including an adherend and a polyurethane adhesive including a carbamate exchange catalyst adhered thereon, wherein the polyurethane adhesive is configured to retain adhesive strength over one or more healing cycles. In some embodiments, retaining adhesive strength over one or more healing cycles is an average strength recovery ratio of at least 80% per healing cycle. The polyurethane adhesive may retain adhesive strength over five or more healing cycles.

In some embodiments, the polyurethane adhesive is adhered to the adherend with a covalent bond. The covalent bond may be reversible. In some embodiments, the adherend includes functional groups capable of reversible bonding with the polyurethane adhesive. In some embodiments, the adherend comprises exposed surface hydroxyl groups.

The present disclosure also provides a method including healing the polyurethane adhesive after a load has been applied to the polyurethane adhesive of the article as described herein. The polyurethane adhesive may be healed after adhesive failure or prior to adhesive failure. In some embodiments, healing the polyurethane adhesive comprises heating the polyurethane adhesive to a carbamate exchange temperature between 110° C. and 220° C. In further embodiments, the polyurethane adhesive is heated to the carbamate exchange temperature for carbamate exchange time between 30 minutes and 4 hours.

The polyurethane adhesive may be configured to retain adhesive strength over one or more healing cycles. In some embodiments, the polyurethane adhesive retains adhesive strength over five or more healing cycles. In some embodiments, retaining adhesive strength over one or more healing cycles is an average strength recovery ratio of at least 80% per healing cycle.

A method including applying a polyurethane adhesive including a carbamate exchange catalyst to an adherend is also described herein. The polyurethane adhesive is configured to retain adhesive strength over one of more healing cycles. In some embodiments, applying the polyurethane adhesive to the adherend includes forming a covalent bond between the polyurethane adhesive and the adherend. The covalent bond may be formed by heating the polyurethane adhesive to a carbamate exchange temperature between 110° C. and 220° C. In some embodiments, the polyurethane adhesive is heated to the carbamate exchange temperature for carbamate exchange time between 30 minutes and 4 hours. The covalent bond may be reversible. The adherend may include functional groups capable of reversible bonding with the polyurethane adhesive. In some embodiments, the adherend comprises exposed surface hydroxyl groups. The method may further include healing the polyurethane adhesive.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. General scheme of crosslinked PU films cured using heat (catalyst-free control film) or 1 mol % Zr(tmhd)₄ (CAN film).

FIG. 2A. FT-IR of catalyst-free control film and CAN film containing 1 mol % Zr(tmhd)₄.

FIG. 2B. Allophanate formation between carbamate and excess isocyanate.

FIG. 2C. DMTA of control film and CAN film.

FIG. 3A. Stress relaxation analysis of control and CAN films at 160° C. Dotted blue line indicates stretched exponential function fit to CAN film SRA.

FIG. 3B. Relaxation spectrum corresponding to CAN film at 160° C.

FIG. 4. Lap shear strength of control film, CAN film, and commercial PU adhesive Gorilla Glue. Between each healing cycle, samples were clamped and cured at 150° C. for 2 hours. The numbers above each bar indicate the number of measurable samples out of the total; other samples broke prior to testing.

FIG. 5A. Image of adhesive joint between two glass slides post curing for 2 hours at 150° C., CAN film area measuring 1 square inch.

FIG. 5B. CAN film adhered to glass can hold over 15 kg of weight without failure.

FIG. 5C. The sample of FIG. 5A was easily separated after heating with a heat gun for 30 seconds to recover substrates and adhesive film.

FIG. 6A. Stress-strain curves for control film, pristine CAN film, and reprocessed CAN film.

FIG. 6B. Image of reprocessed CAN film showing overall uniformity.

FIG. 6C. Image of reprocessed control film, from which a homogenous film was not obtained.

FIG. 7. Lap shear testing results of base CAN formulation (polypropylene glycol, 15 wt % crosslinker, NCO:OH=1.03) with varying amounts of added rigid polyol on glass substrates measuring 25.4 mm (W)×1.2 mm (T)×76.2 mm (L). The maximum strength was reached at 10 wt % rigid polyol, beyond this the film became too stiff and lost strength.

FIG. 8. DSC thermograms of CAN, CAN reprocessed, and control films. Films are homogenous, showing a single T_{g} with agreeance between all three samples.

FIG. 9. Experimental SRA data (solid) plotted alongside KWW fit (dashed) obtained from Equation 2 for CAN film samples.

FIG. 10A. Relaxation spectra for CAN film sample 1.

FIG. 10B. Relaxation spectra for CAN film sample 2.

FIG. 10C. Relaxation spectra for CAN film sample 3.

FIG. 11. TGA of the CAN films, indicating their stability to 313° C.

FIG. 12. Isothermal TGA of the PU CAN obtained at the reprocessing temperature of 150° C., which indicates its stability under these conditions.

FIG. 13. FT-IR of control film, as-synthesized CAN film, and CAN film after 5th healing cycle from lap shear testing showing no chemical differences.

FIG. 14. Initial lap shear strengths of CAN film and control film on plasma treated glass, regular glass, and silanized glass. Samples adhered to silanized glass had a significantly lower strength as determined by a one-tailed T-test with unequal variance.

FIG. 15. Lap shear strengths of pristine CAN and CAN samples submerged in DI water for 72 hours. The average lap shear strengths do not vary between samples, indicating that the adhesive is hydrolytically stable.

FIG. 16. FT-IR of commercial PU adhesive and commercial PU adhesive with 2 wt % Zr(tmhd)₄. Urea formation is seen by the peak at 1657 cm⁻¹ and was accelerated when 2 wt % Zr(tmhd)₄ was added.

FIG. 17. Initial lap shear results of commercial PU adhesive and commercial PU adhesive with 2 wt % Zr(tmhd)₄. Excessive bubbling, caused by the catalysis of the blowing reaction between isocyanate and water producing urea, resulted in a lower lap shear strength.

FIG. 18. FT-IR of control film, as-synthesized CAN film, compression molded CAN film, and cryomilled CAN powder.

FIG. 19. MTA of control, pristine CAN, and reprocessed CAN films indicating complete network recovery.

### DETAILED DESCRIPTION OF THE INVENTION

Thermoset polyurethanes (PUs) have been successfully reprocessed as covalent adaptable networks (CANs) by catalyzing carbamate exchange. Here we extend bond exchange beyond the internal network crosslinks to create a dynamic urethane adhesive. Interfacing PU CANs to substrates with nucleophilic functional groups creates adhesives capable of reversible transcarbamoylation with the substrate, which has not been demonstrated previously by CAN adhesives. Two thermoset PU films were utilized in the Examples, one containing the green carbamate exchange catalyst Zr(tmhd)₄ and the other containing no catalyst. Although otherwise identical in chemical and network properties, as indicated by FT-IR spectroscopy and dynamic mechanical thermal analysis (DMTA), the film containing catalyst showed dynamic bond exchange behavior through stress relaxation analysis. When evaluated as an adhesive, the CAN film exhibited self-healing properties and retained its adhesive strength for five cycles, which is attributed to reversible covalent bonding to the glass substrate.

This work demonstrates the use of industrially relevant CANs to prepare adhesives and their potential value in an application that presently employs PUs as single-use materials. Herein, we demonstrate that PU CANs based on carbamate exchange have self-healing properties that allow for the retention of adhesive strength over multiple cycles through direct covalent bonding to the substrate. Moreover, these adhesives are industrially relevant and may be synthesized from common PU monomers, polypropylene glycol and methylene diphenyl diisocyanate (MDI). Since the network crosslinks are dynamic, they can be reprocessed using compression molding with full recovery of chemical, network, and mechanical properties. This work extends beyond the traditional view of internal bond exchange in CANs, allowing for a clear path to industrially relevant applications.

The present disclosure provides an article including a polyurethane adhesive comprising a carbamate exchange catalyst, wherein the polyurethane adhesive retains adhesive strength over one or more healing cycles. Carbamate exchange catalysts are compounds that accelerate the exchange of carbamate bonds in polyurethanes, making the materials flowable for recycling and reprocessing. These catalysts enable the creation of covalent adaptable networks (CANs), which are materials that allow for properties like self-healing and transformation into new forms through processes like melt reprocessing or twin-screw extrusion. In exemplary embodiments, the carbamate exchange catalyst is zirconium tetrakis(2,2,6,6-tetramethyl-3,5-heptanedionate) [Zr(tmhd)₄].

A healing cycle is a process that begins after a polyurethane adhesive is partially or completely compromised and proceeds through phases to restore function. In some embodiments, retaining adhesive strength over one or more healing cycles is an average strength recovery ratio of at least 10%, at least 20%, at least 30%, at least 40%, at least 50%, at least 60%, at least 70%, at least 80%, at least 90%, or at least 95% per healing cycle. In preferred embodiments, retaining adhesive strength over one or more healing cycles is an average strength recovery ratio of at least 80% per healing cycle. In some embodiments, the polyurethane adhesive retains adhesive strength over one, two, three, four, five, or more healing cycles. In some embodiments, the polyurethane adhesive retains adhesive strength over five healing cycles.

In some embodiments, the polyurethane adhesive is adhered to the adherend with a covalent bond. The covalent bond may be reversible. In some embodiments, the adherend includes functional groups capable of reversible bonding with the polyurethane adhesive. In preferred embodiments, the adherend includes exposed surface hydroxyl groups. In alternative embodiments, the adherend includes thiols or primary amines with the resulting dynamic bond being a thiourethane or urea, respectively.

The present disclosure further provides a method including healing the polyurethane adhesive after a load has been applied to the polyurethane adhesive of the article as described herein. The polyurethane adhesive may be healed after adhesive failure or prior to adhesive failure. In preferred embodiments, retaining adhesive strength over one or more healing cycles is an average strength recovery ratio of at least 80% per healing cycle. In some embodiments, the polyurethane adhesive is configured to retain adhesive strength over one or more healing cycles. In preferred embodiments, the polyurethane adhesive retains adhesive strength over five or more healing cycles.

The present disclosure also provides a method including applying a polyurethane adhesive comprising a carbamate exchange catalyst to an adherend, wherein the polyurethane adhesive is configured to retain adhesive strength over one of more healing cycles. In some embodiments, applying the polyurethane adhesive to the adherend comprises forming a covalent bond between the polyurethane adhesive and the adherend. The covalent bond may be reversible. In some embodiments, the adherend includes functional groups capable of reversible bonding with the polyurethane adhesive. In preferred embodiments, the adherend includes exposed surface hydroxyl groups. In some embodiments, the method further comprises healing (or curing) the polyurethane adhesive.

The effective bond-exchange temperature (BET) refers to the temperature at which reversible reactions, such as those between isocyanate and hydroxyl groups in polyurethane, occur effectively. The BET can vary depending on the molecular structure, chain length, degree of crosslinking, and the specific functional groups involved. The effective bond-exchange temperature may be less than or equal to 110° C., 120° C., 130° C., 140° C., 150° C., 160° C., 170° C. 180° C., 190° C., 200° C., 210° C., and 220° C. In some embodiments, the effective bond-exchange temperature is between 110° C. and 220° C., between 150° C. and 210° C., between 160° C. and 200° C., or between 170° C. and 190° C.

The effective bond-exchange time refers to the duration over which the polymer chains in a material are subjected to the BET and undergo reversible bond exchanges. The bond-exchange time can impact processing and material properties. The effective bond-exchange time may be selected for the polymer to reach a desired level of bond exchange for its processing and final characteristics. The effective bond-exchange time is less than or equal to 5 hours, less than or equal to 4 hours, less than or equal to 3 hours, less than or equal to 2 hours, less than or equal to 1 hour, less than or equal to 45 minutes, less than or equal to 30 minutes, less than or equal to 15 minutes, less than or equal to 10 minutes, less than or equal to 5 minutes, or less than or equal to 1 minute. In some embodiments, the effective bond-exchange time is less than or equal to 2 hours. In other embodiments the effective bond-exchange time is between 30 minutes and 4 hours, 1 hour and 2 hours, 1 hour and 3 hours, or 1 hour and 4 hours. In some embodiments, the effective bond-exchange time is 2 hours.

“Adherend” means a surface to which an adhesive adheres. An adherend may include a body held to another body by an adhesive. The adherend may comprise exposed surface functional groups that allow for adhesion of an adhesive to the adherend. The surface functional groups may form reversible covalent bonds. The reversible covalent bonds may include urethane bonds. Suitably, the adherend may include exposed nucleophilic functional groups, such as hydroxyl groups. Hydroxyl groups on the adherend may react with urethane groups within an adhesive.

“Block” means a portion of a macromolecule, comprising many constitutional units, that has at least one constitutional or configurational feature which is not present in the adjacent portions.

“Branch” means an oligomeric or polymeric offshoot from a macromolecular chain.

“Branch point” means a point on a chain at which a branch is attached.

“Branch unit” means a constitutional unit containing a branch point.

“Catalyst” means a substance that increases the rate of a reaction without modifying the overall Gibbs energy change in the reaction. Suitably the catalyst may be a coordination entity comprising a central atom and one or more ligands joined to the central atom. Suitably the central atom is a metal. “Ligand” means an atom or group joined to a central atom.

“Chain” means a whole or part of a macromolecule, an oligomer molecule, or a block, comprising a linear or branched sequence of constitutional units between two boundary constitutional units, each of which may be either an end-group, a branch point, or an otherwise-designated characteristic feature of the macromolecule.

“Compounding” means to blend or mix a substance, such as any of the polyurethane compositions described herein, within a compounding device. Suitably the substance is compounded at an effective bond-exchange temperature for an effective bond-exchange time.

“Constitutional unit” means an atom or group of atoms (with pendant atoms or groups, if any) comprising a part of the essential structure of a macromolecule, an oligomer molecule, a block, or a chain.

“Copolymer” means a polymer derived from more than one species of (real, implicit, or hypothetical) monomer.

“Covalent network” or “covalent polymer network” means a network in which the permanent paths through the structure are all formed by covalent bonds.

“Dynamic network” or “dynamic polymer network” or “covalent adaptable network” means a covalent network that is capable of undergoing bond-exchange reactions at a temperature above an effective bond-exchange temperature. A dynamic network may demonstrate viscoelastic liquid properties above the freezing transition temperature.

“Foam” means a multiphasic material comprising gas dispersed in a polymer. The foam may be formed by trapping pockets of gas in a solid or liquid. Foams may be prepared by physical or chemically blowing. In some embodiments, the foam may be a closed-cell foam where the gas forms discrete, completely surrounded pockets. In other embodiments, the foam may be an open-cell foam where the gas pockets are interconnected. Suitably the polymer is a polyurethane (“polyurethane foam”).

“Homopolymer” means a polymer derived from one species of (real, implicit or hypothetical) monomer. Polymers may be made by the mutual reaction of complementary monomers. These monomers can readily be visualized as reacting to give an ‘implicit monomer’ or ‘hypothetical monomer’, the homopolymerization of which would give the actual product, which can be regarded as a homopolymer.

“Inorganic polymer” means a polymer or polymer network with a skeletal structure that does not include carbon atoms. Examples include, without limitation, polyphosphazenes, polysilicates, polysiloxanes, polysilanes, polysilazanes, polygermanes, and polysulfides.

“Isocyanate constitutional unit” means a constitutional unit comprising at least one isocyanate group, i.e., —NCO. Suitably the isocyanate constitutional unit may comprise more than one isocyanate group such as two, three, or four isocyanate groups. In some embodiments, the isocyanate constitutional unit is an aromatic isocyanate constitutional unit. As used herein, an “aromatic isocyanate constitutional unit” means an isocyanate constitutional unit having an isocyanate group pendant from an aryl group such a phenyl or other aromatic ring. Isocyanate groups are capable of making reversible carbamate bonds with a polymer, network, or an adherend. Suitable isocyanate groups are capable of making reversible carbamate bonds with a polymer, network, or an adherend.

“Lewis acid” means a molecular entity (and the corresponding chemical species) that is an electron-pair acceptor and therefore able to react with a Lewis base to form a Lewis adduct, by sharing the electron pair furnished by the Lewis base.

“Linear chain” means a chain with no branch points between the boundary units.

“Macromolecule” or “polymer molecule” means a molecule of high relative molecular mass, the structure of which essentially comprises the multiple repetition of units derived, actually or conceptually, from molecules of low relative molecular mass.

“Mechanically processed” means to mechanically alter a substance, e.g., by mechanically grinding, cutting, chopping, applying pressure, or applying some other form of mechanical force. Suitably, the substance such as the polyurethane compositions described herein may be mechanically processed to fragment the substance into pieces, grains, granules, or particles. Mechanical processing includes applying pressure to the polyurethane adhesive such as via compression.

“Monomer” means a substance composed of monomer molecules.

“Monomer molecule” means a molecule which can undergo polymerization, thereby contributing constitutional units to the essential structure of a macromolecule.

“Monomeric unit” means the largest constitutional unit contributed by a single monomer molecule to the structure of a macromolecule or oligomer molecule.

“Network” means a highly ramified macromolecule in which essentially each constitutional unit is connected to each other constitutional unit and to the macroscopic phase boundary by many permanent paths through the macromolecule, the number of such paths increasing with the average number of intervening bonds; the paths must on the average be co-extensive with the macromolecule.

“Network polymer” means a polymer composed of one or more networks.

“Nucleophilic functional group” means a functional group characterized by the presence of an electron-rich atom or moiety capable of donating a pair of electrons to an electron-deficient center to form a covalent bond. These groups may participate in chemical reactions by attacking electrophilic centers, thereby initiating substitution or addition processes. The nucleophilic character arises from lone pairs, π-electrons, or negatively charged atoms, which confer reactivity toward electrophiles. Exemplary nucleophilic functional groups include, without limitation, hydroxyl groups.

“Oligomer molecule” means a molecule of intermediate relative molecular mass, the structure of which essentially comprises a small plurality of units derived, actually or conceptually, from molecules of lower relative molecular mass.

“Organic polymer” means a polymer or polymer network with a skeletal structure that includes carbon atoms. Examples include, without limitation, polyethers, polyesters, polycarbonates, polyacrylates, polyolefins, and polybutadienes.

“Polymer” means a substance composed of macromolecules.

“Polymer composition” means a composition comprising two or more different polymers. The polymers may have reactive chemical moieties that can undergo bond exchange. The two or more different polymers may be selected from two or more different classes of polymers, such as polyurethanes, polyesters, and polycarbonates. The two or more different polymers may be between 20 and 80 wt % the polymer composition For two different polymers, the weight ratio of the first homopolymer and second homopolymer may be between 20:80 and 80:20, 25:75 and 75:25, 30:70 and 70:30, 35:65 and 65:35, 40:60 and 60:40, 45:55 and 55:45, or about 50:50. The polymer composition may be a miscible or immiscible polymer blend.

“Polymerization” means a process of converting a monomer or a mixture of monomers into a polymer.

“Prepolymer molecule” means a macromolecule or oligomer molecule capable of entering, through reactive groups, into further polymerization, thereby contributing more than one constitutional unit to at least one type of chain of the final macromolecules.

“Polyurethane adhesive” or “polyurethane composition” means a network formed from urethane bonds that are capable of undergoing urethane bond-exchange reactions, i.e., carbamate exchange reactions. Urethane bond and carbamate bond may be used interchangeably. The polyurethane compositions comprise a network urethane-containing polymer and a polyurethane exchange catalyst permeated within the network polymer. The network polymer may be formed from isocyanate constitutional units and a second constitutional unit having hydroxyl groups capable of reacting with the isocyanate group of the isocyanate constitutional unit. The mol % of the polyurethane exchange catalyst to the total isocyanate functionality may be less than or equal to 5 mol %. Suitably, the mol % may be less than or equal 4 mol %, 3 mol %, 2 mol %, 1 mol %, or less than 1 mol %. In some instances, the mol % of the polyurethan exchange catalyst to the total isocyanate functionality may be less may be at least 0.1 mol %, such as at least 0.2 mol %, 0.3 mol %, 0.4 mol %, or 0.5 mol %. The wt % of the polyurethane exchange catalyst to mass of network urethane-containing polymer may be less than or equal to 5 wt %. Suitably, the wt % may be less than or equal 4 wt %, 3 wt %, 2 wt %, 1 wt %, or less than 1 wt %. In some instances, the wt % of the polyurethane exchange catalyst to mass of network urethane-containing polymer may be at least 0.1 wt %, e.g., 0.2 wt %, 0.3 wt %, 0.4 wt %, 0.5 wt %. The second constitutional unit may be a prepolymer molecule or a branch unit. Suitably the second constitutional unit may function as both a prepolymer molecule and a branch unit. The prepolymer molecule is an organic polymer molecule or an inorganic polymer molecule such as a polyether, a polyester, a polycarbonate, a polyacrylate, a polyolefin, a polybutadiene, a polysulfide, or a polysiloxane having one or more hydroxyl groups capable of reacting with an isocyanate group. When the prepolymer molecule also functions as a branch unit, the prepolymer molecule has a three or more hydroxyl groups capable of reacting with urethane groups and typically a plurality of hydroxyl groups in proportion to the number of constitutional units of the prepolymer molecule. The network polymer may also be formed from urethane-containing monomers featuring other polymerizable groups, including but not limited to, acrylates, methacrylates, or other polymerizable olefins.

“Bond-exchange catalyst” means a catalyst that increases the rate of a bond-exchange reaction, such as a carbamate bond exchange reaction. Suitable metal for the catalyst includes Sn, Bi, Fe, Zr, Ti, Hf, Al, Zn, Cu, Ni, Co, Mn, V, Sc, Y, Ce, or Mo. Suitable ligands for the catalyst include, without limitation, branched or unbranched, substituted or unsubstituted carboxylates, alkyls, alkoxides, 1,3-diketones, 1,2-diketones, sulfonates, sulfonamides, amines, diamines, carbonates, phosphates, nitrates, halides, catecholates, hydroxamates, hydroxides, or any combination thereof. The ligand may be branched or unbranched, substituted or unsubstituted. Exemplary ligands include acetylacetonate (acac), isopropoxide (OiPr), neodecanoate (neo), laurate, butyl, ethylhexanoate, and 2,2,6,6-Tetramethyl-3,5-heptanedione (tmhd), trifluoromethanesulfonate, trifluoromethanesulfonamide, cyclopentadiene, pyridine salicylidene diamine, phosphine, or any combination thereof. Exemplary catalysts include, without limitation, dibutyltin dilaurate (DBTDL), Bi(neo)₃, Fe(acac)₃, Ti(OiPr)₂(acac)₂, Hf(acac)₄, Zr(acac)₄, Mn(acac)₂, Bi(oct)₃, Zn(tmhd)₂, zirconium tetrakis(2,2,6,6-tetramethyl-3,5-heptanedionate), or any combination thereof.

“Thermosetting polymer” or “thermoset” is a polymer that is irreversibly hardened by curing from a soft solid of viscous liquid prepolymer or resin.

“Vitrimer” means a network polymer that can change its topology by thermally activated bond-exchange reactions that occur through an associative mechanism, such that the total number of covalent bonds in the network polymer does not decrease transiently while the bond-exchange reactions are taking place. At elevated temperatures, the bond-exchange reactions occur at an effectively rapid rate and the network polymer has properties of a viscoelastic liquid. At low temperatures, the bond-exchange reactions are slowed and the network polymer behaves like a thermosetting polymer.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

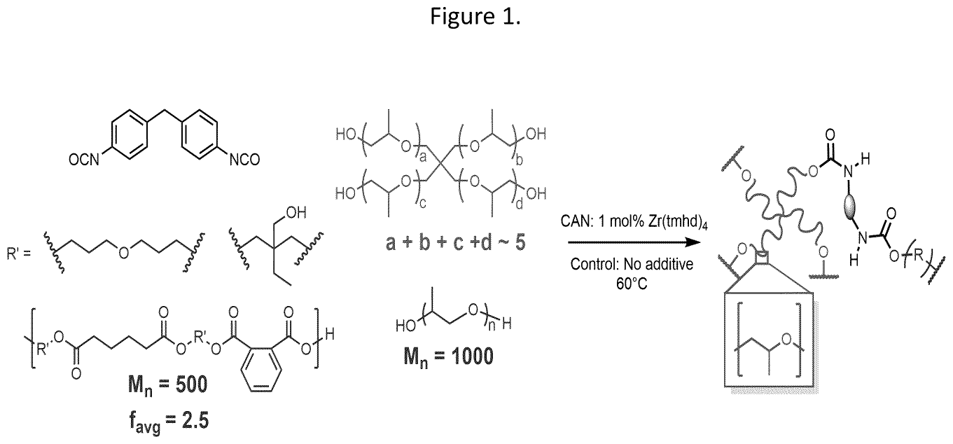

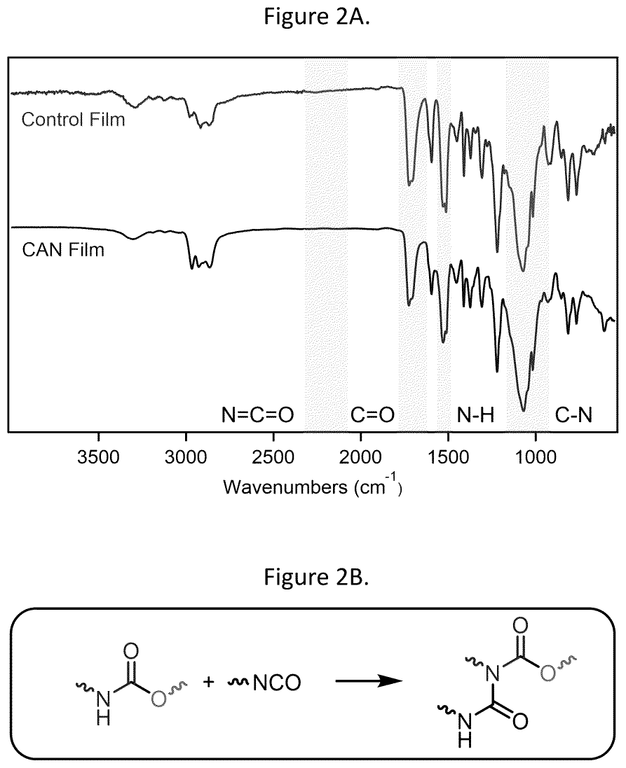

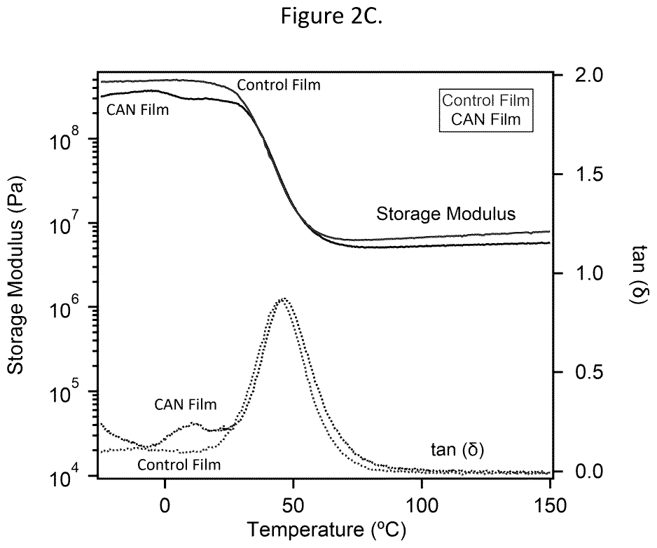

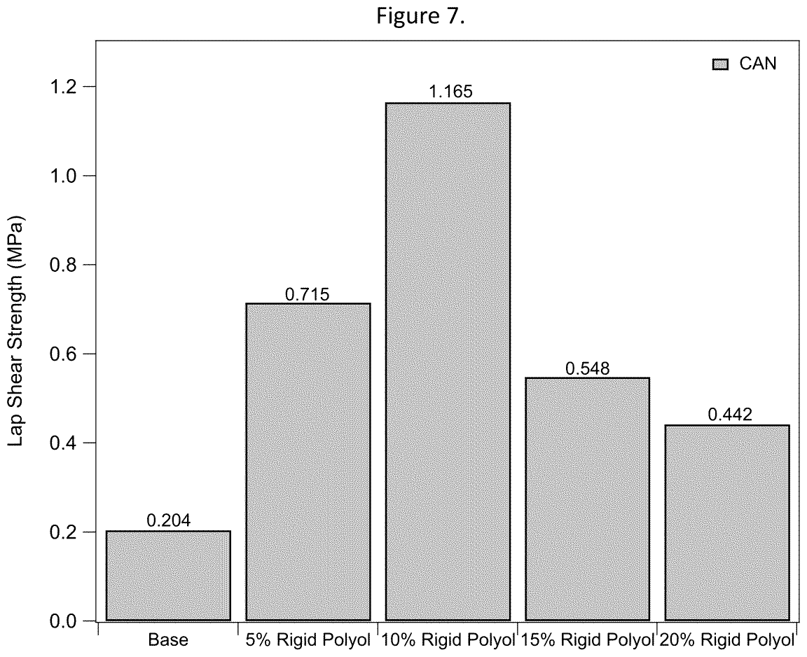

To evaluate the impact of dynamic covalent bonds on mechanical and adhesive properties, two thermoset PU films were synthesized: one containing 1 mol % carbamate exchange catalyst, zirconium tetrakis(2,2,6,6-tetramethyl-3,5-heptanedionate) [Zr(tmhd)₄] (CAN film), and a control film containing no additional additives. Polypropylene glycol, a common polyol used in commercial PU adhesives, was chosen as the main hydroxyl-containing component in the network.³ Hard segments of the network were comprised of MDI and a rigid polyester polyol (FIG. 1). The polyester polyol provided additional rigidity, polarity, and hydrogen bond acceptors to increase the strength of the network (FIG. 7). Since Zr(tmhd)₄ is both a carbamate exchange and gelling catalyst, no additional heat was needed to cure the network, while the control film containing no catalyst was heated at elevated temperature to promote polycondensation between isocyanate and hydroxyl groups. Both CAN and control film show complete conversion of the isocyanate monomer, as indicated by the lack of an N═C═O stretch in Fourier-transform infrared spectroscopy (FT-IR), which typically appears at 2285 cm⁻¹ (FIG. 2A). Gel fractions in dichloromethane upwards of 96% were obtained for both films, further confirming complete network formation (Table 2).

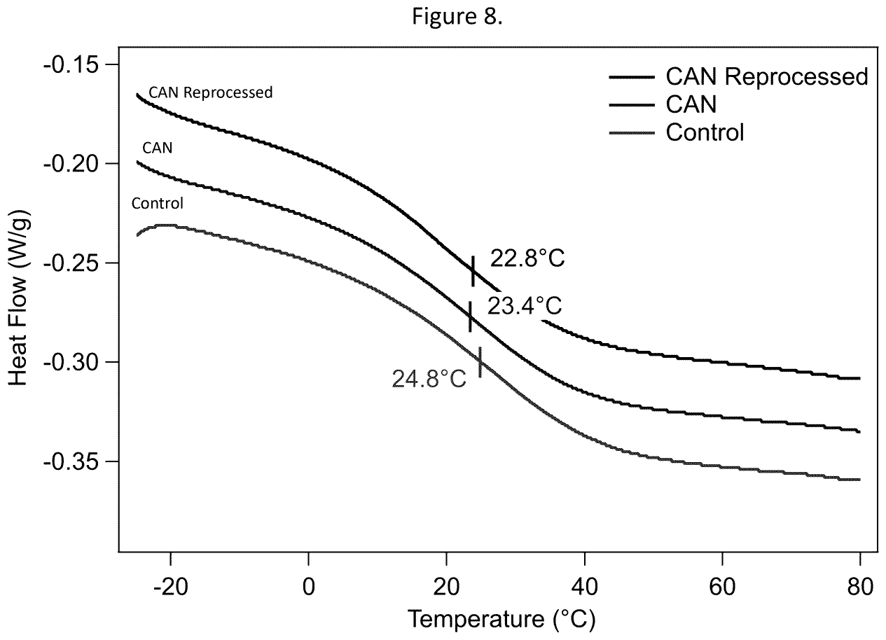

Characterization of these films using FT-IR and dynamic mechanical thermal analysis (DMTA) show that the CAN and control film are chemically indistinguishable and have similar network properties. Both the CAN and control film were synthesized with 3 mol % excess isocyanate relative to hydroxyl groups. As a result, both networks display FT-IR stretches consistent with allophanate formation within the PU network (FIG. 2B). The C—O stretch ranging from 1708-1725 cm⁻¹ and the N—H deformation at 1513-1533 cm⁻¹ are split peaks, indicating two separate carbonyl and urethane environments (FIG. 2A). Additionally, an intense C—N stretch is seen at 1069 cm⁻¹. Combining the lack of a urea peak (typically seen around 1650 cm⁻¹) and the observed peak splitting, it can be concluded that excess isocyanates form allophanates within the PU network. Furthermore, DMTA of both films reveal a rubbery plateau in the storage modulus, indicating a crosslinked network (FIG. 2C). Using Equation 1, the average molecular weight between crosslinks was calculated to be 782 g/mol for the CAN film and 525 g/mol for the control film (Table 2). Given that the smallest monomer between crosslinks has a molecular weight of 250 g/mol, the films have almost identical crosslink densities. A small peak can be seen in the tan (δ) curve for the CAN film just above 0° C. (FIG. 2C). Since only one T_{g} is seen using differential scanning calorimetry (FIG. 8), the CAN film is homogenous and the small tan (δ) peak can be assigned as a beta transition rather than phase separation within the network. The presence of the bulky Zr(tmhd)₄ catalyst may contribute to localized backbone movements of the soft segments, resulting in a small beta transition.³⁵ Overall, spectral and thermomechanical characterization of the CAN and control film supports the conclusion that these films are identical in both chemical and network properties, therefore any performance differences between the two films can be directly attributed to the presence or absence of dynamic urethane bonds in the network.

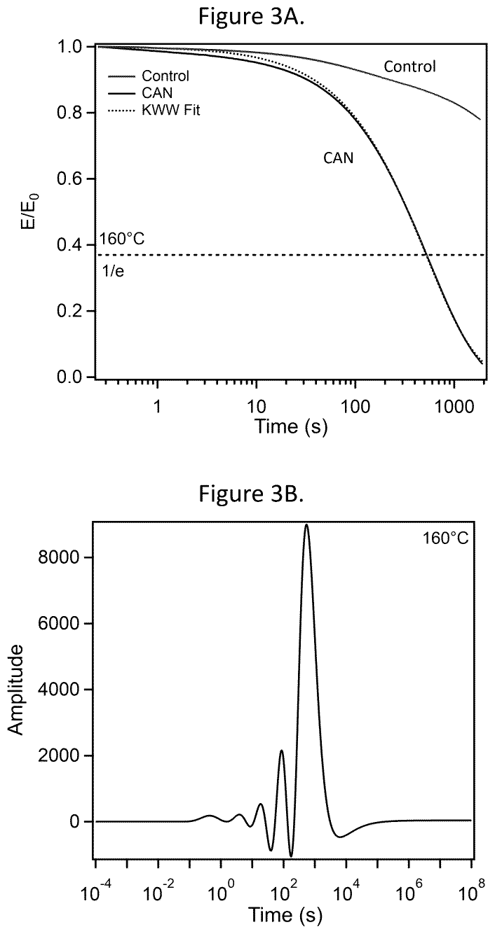

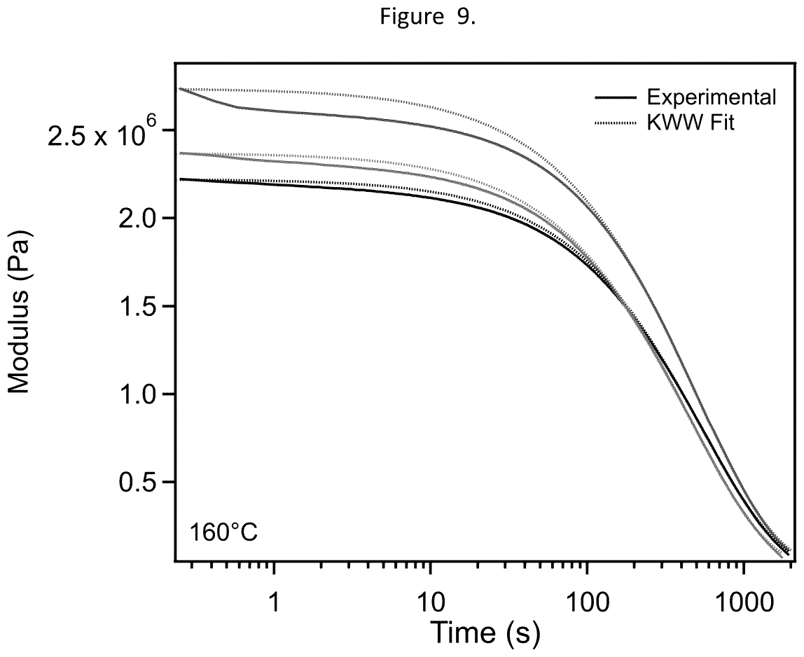

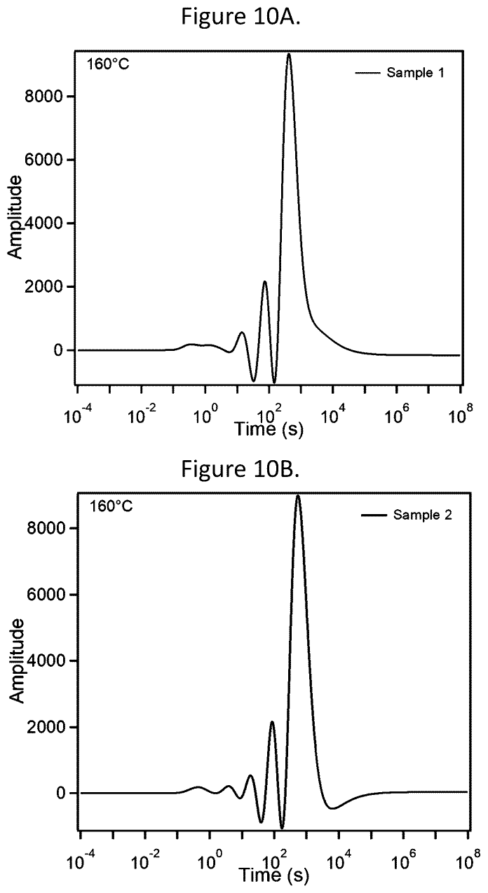

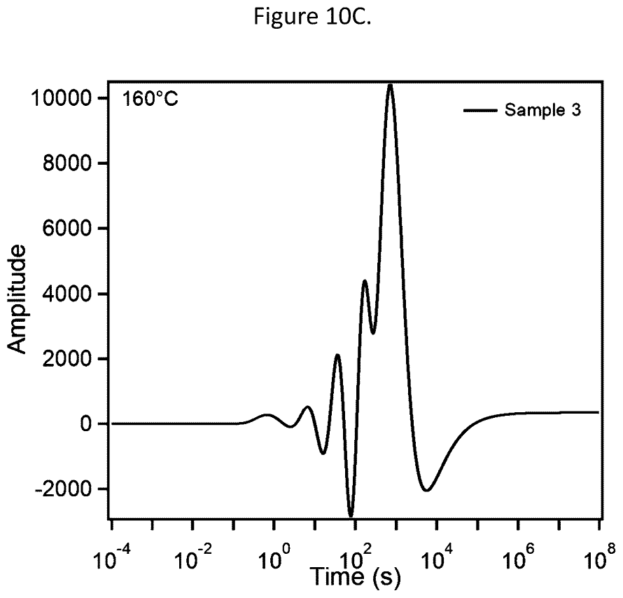

The addition of Zr(tmhd)₄ in the CAN film creates dynamic urethane bonds that enable stress relaxation. Applying force to a dynamic network allows the bonds to undergo exchange reactions which relax the applied stress. Performing stress relaxation analysis (SRA) at typical reprocessing temperatures provides insight into the reprocessability of the dynamic network. When subjected to SRA at 160° C., the CAN film completely relaxes stress within 30 minutes, and the control film only partially relaxes stress under the same conditions (FIG. 3A). Stress relaxation in the control film is attributed to a combination of hydrogen bonding dissociation, transallophanation, and urethane dissociation due to high temperature.³⁶ Since these processes occur at such long time scales, the urethane bonds in the control film can be treated as essentially static. The characteristic relaxation time, τ*, is defined as the time at which the remaining stress is 1/e of the initial value. The CAN film had an average τ* of 489 seconds at 160° C. (Table 3). Further analysis by applying a stretched exponential function fit (Equation 2) to the stress relaxation data afforded an average beta value of 0.85 (Table 3) with an average correlation coefficient of 0.9995 (FIG. 3A, FIG. 9, Table 4). In this analysis, beta describes the distribution of relaxation events in the network, with a beta value of 1 corresponding to a single stress relaxation mechanism. In the CAN film there is one main mode of relaxation that can be attributed to urethane exchange. Deconvolution of a typical stress relaxation plot using a generalized Maxwell model produces a relaxation spectrum in which the characteristic time scale of each relaxation process is a local maximum (FIG. 3B). For the CAN film, the global maximum occurs at 555 seconds (FIG. 3B, FIG. 10, Table 4), which is similar to the τ* value of 489 seconds. This difference further confirms that dynamic behavior in the film is primarily associated with carbamate exchange, enabled by Zr(tmhd)₄. More minor relaxation processes appear at earlier timescales, and are observed resulting from hydrogen bonding and transallophanation that may be present in the network (FIG. 3B). Since urethane exchange is the clear mechanism of stress relaxation in the CAN film, we hypothesized that transcarbamoylation could occur with surface hydroxyl groups for reversible covalent bonding with a substrate.

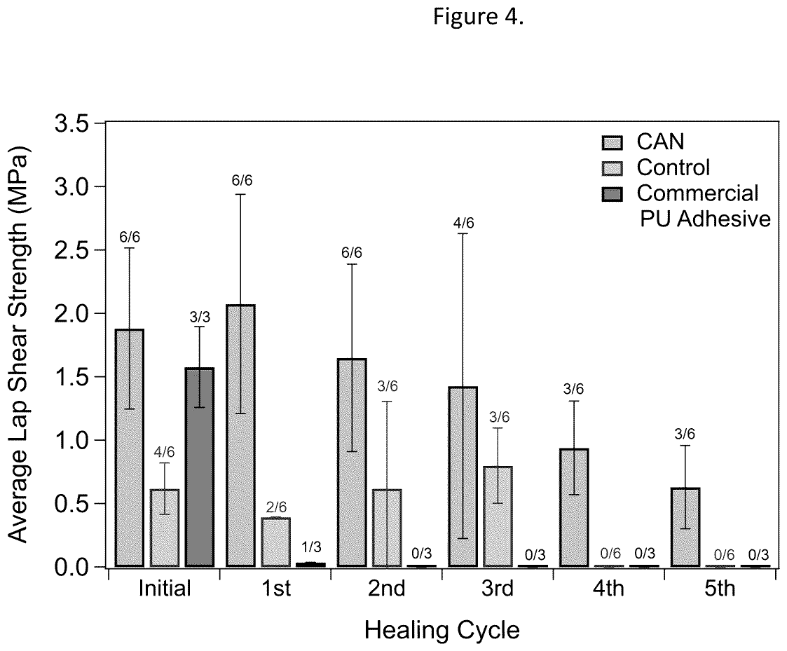

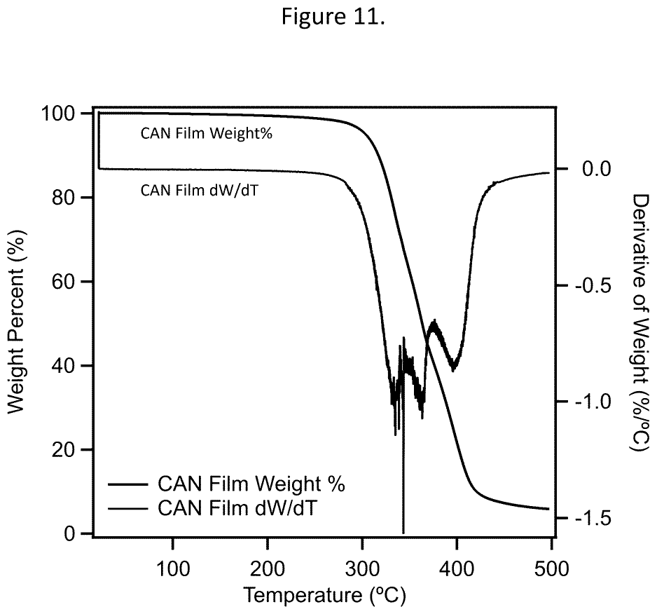

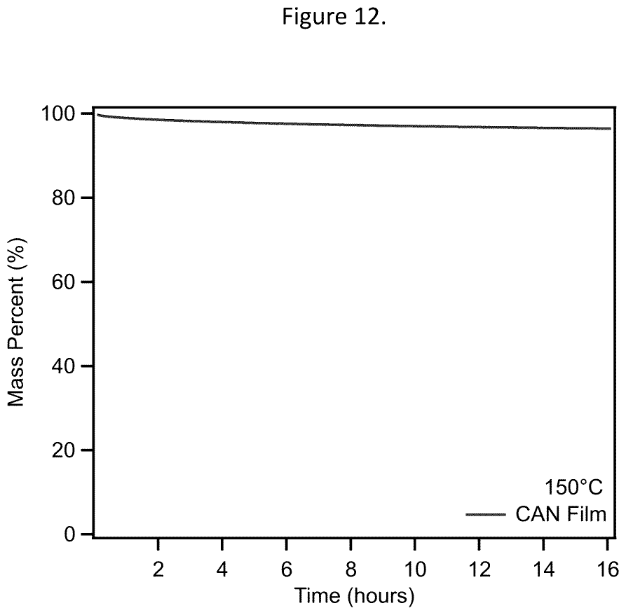

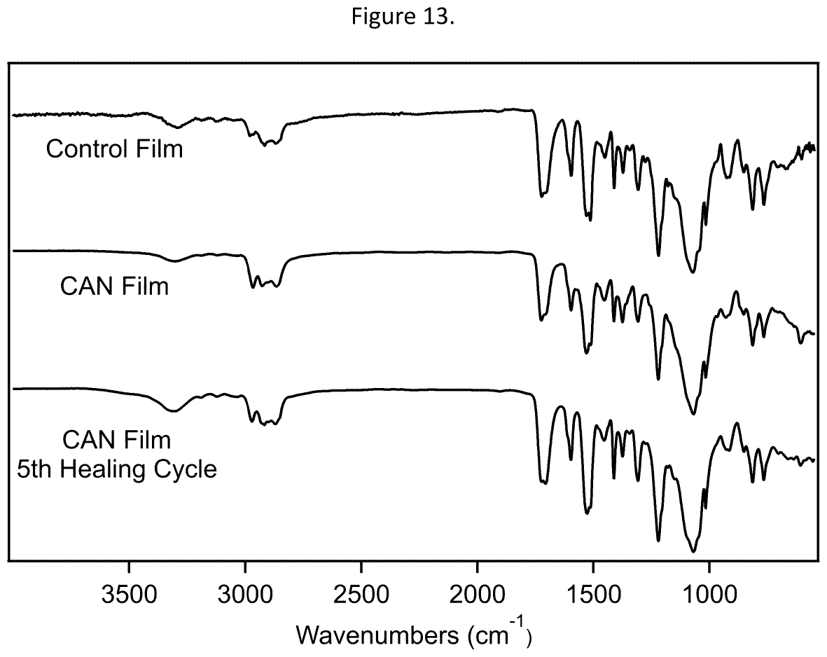

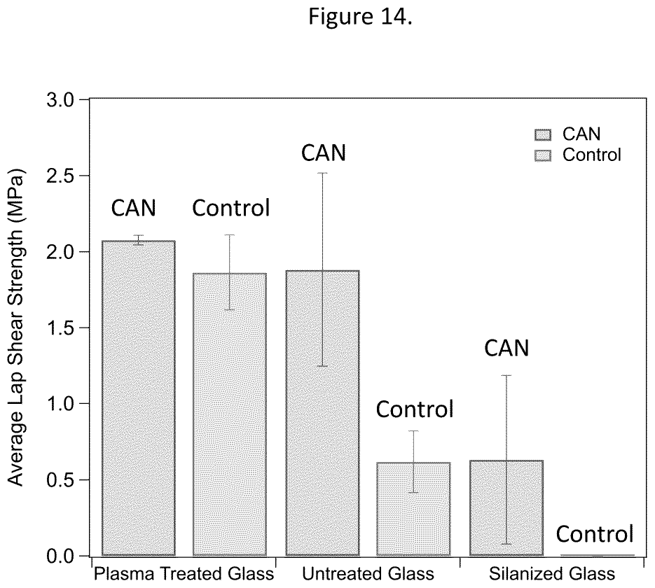

Lap shear testing demonstrated the self-healing ability of the CAN film compared to the control film and a commercial PU adhesive. Both the pre-synthesized CAN and control film were adhered to glass substrates by cutting the film to a specific size, then clamping and curing the joint at 150° C. for two hours, allowing transcarbamoylation to occur between the films and surface hydroxyl groups on the glass. Employing thermogravimetric analysis (TGA), the CAN film was determined to be thermally stable under these curing conditions, indicated by an onset degradation temperature of 313° C. and less than 4% mass loss when held at 150° C. for 16 hours (FIG. 11, FIG. 12). The commercial PU adhesive was applied directly to wetted glass substrates and allowed to cure at room temperature, in accordance with product instructions. Initially, the CAN film and commercial PU adhesive performed similarly with an average lap shear strength around 1.5 MPa, while the control film had a significantly lower average lap shear strength 0.7 MPa (FIG. 4). Since the films were post cured prior to lap shear sample preparation, all covalent bonding to the surface, and subsequently the lap shear strength, is a result of the reversible transcarbamoylation reaction. The control film does not contain catalyst that can accelerate transcarbamoylation, so there is likely to be little covalent bonding between the surface and the film, resulting in a lower average lap shear strength. Additionally, both the CAN and control film experienced adhesive failure, indicating that the weakest point in the lap shear sample occurred between the substrate and film. Therefore, the inherent strength of the adhesive films is larger than the measured lap shear strength. Conversely, the commercial PU adhesive experienced cohesive failure, meaning that the true network strength is accurately measured with lap shear testing. To heal the lap shear samples, the substrates and films were clamped together and heated at 150° C. for two hours. While the commercial PU adhesive showed no recovery of lap shear strength, the CAN film retained its adhesive strength over five healing cycles, demonstrating reversible covalent bonding to the substrate through transcarbamoylation between surface hydroxyl groups and the CAN film (FIG. 4). The control film recovered some of its adhesive properties through uncatalyzed bond exchange at the high curing temperature, however the control film did not recover any adhesive strength beyond the third healing cycle. In each healing cycle, the CAN film significantly outperformed both the control film and the commercial PU benchmark (p<0.1 using a one-tailed T-test with unequal variance). The CAN film exhibited an average strength recovery ratio of 86% over the course of the experiment. After 5 healing cycles, the CAN film showed no chemical differences using FT-IR (FIG. 13), indicating that a lack of available surface hydroxyl groups on the glass substrate may result in lower transcarbamoylation and consequently a lower lap shear strength. Furthermore, when the adhesive films were applied to silanized glass substrates, which lack surface hydroxyl groups, the lap shear strength was significantly lower than the untreated glass substrates (FIG. 14). In contrast, after plasma treating the glass substrates to increase the number of surface hydroxyl groups, both the CAN and control films showed an increase in average lap shear strength (FIG. 14). This confirms that dynamic covalent bonding of the CAN film to substrates occurs through transcarbamoylation with surface hydroxyl groups.

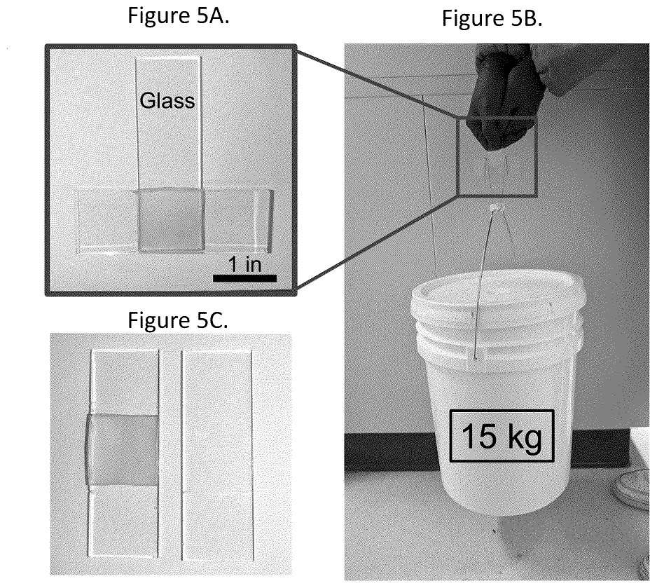

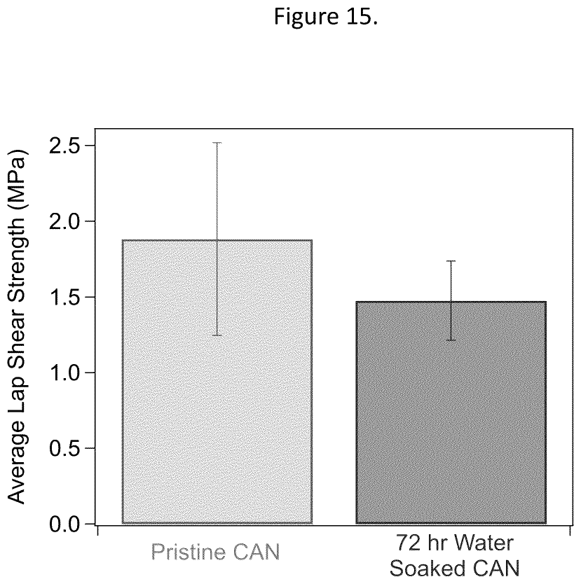

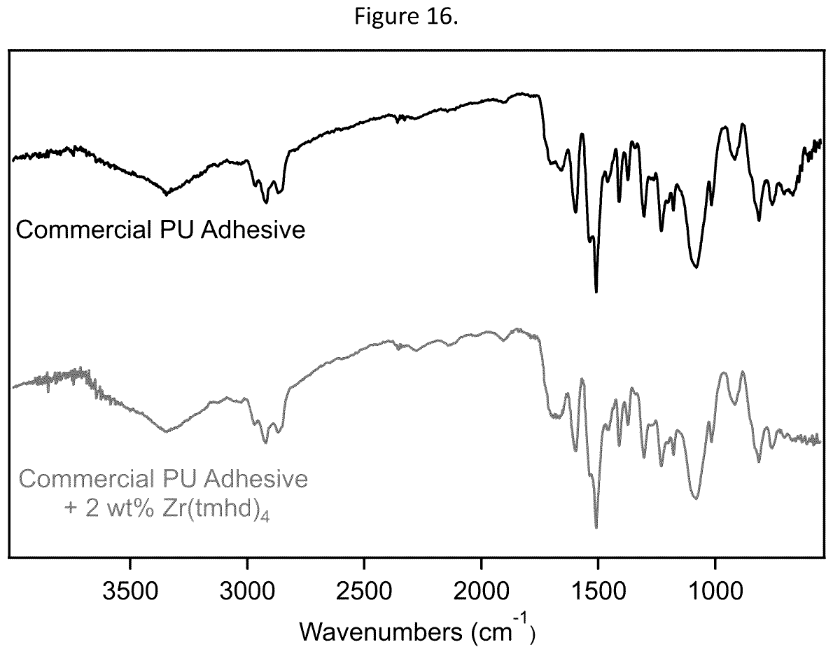

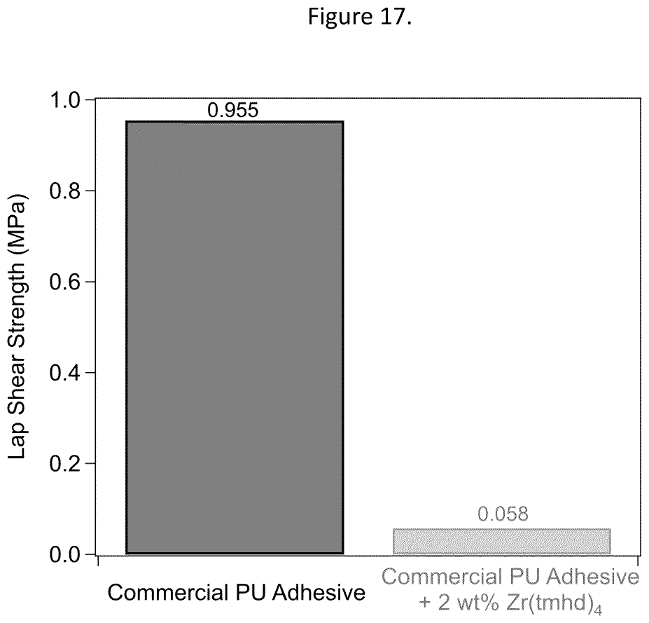

While the CAN film is extremely strong, substrates can be recovered by simply heating the adhered sample, causing the covalent bonds to become dynamic and easily detach from the glass (FIG. 5). Additionally, the CAN film exhibited excellent water resistance. After submerging the prepared lap shear sample in DI water for 72 hours, the average lap shear strength remained constant (FIG. 15). Directly converting the PU commercial adhesive to a CAN via the addition of carbamate exchange catalyst was limited by the blowing reaction between isocyanate and water. The exchange catalyst accelerated the blowing reaction, evidenced by obvious urea formation seen through excessive bubbling and a significant decrease in lap shear strength (FIG. 16, FIG. 17). These results demonstrate the versatility of dynamic networks, extending beyond exchange within the network to transcarbamoylation between PU CAN films and surfaces for improved adhesive properties.

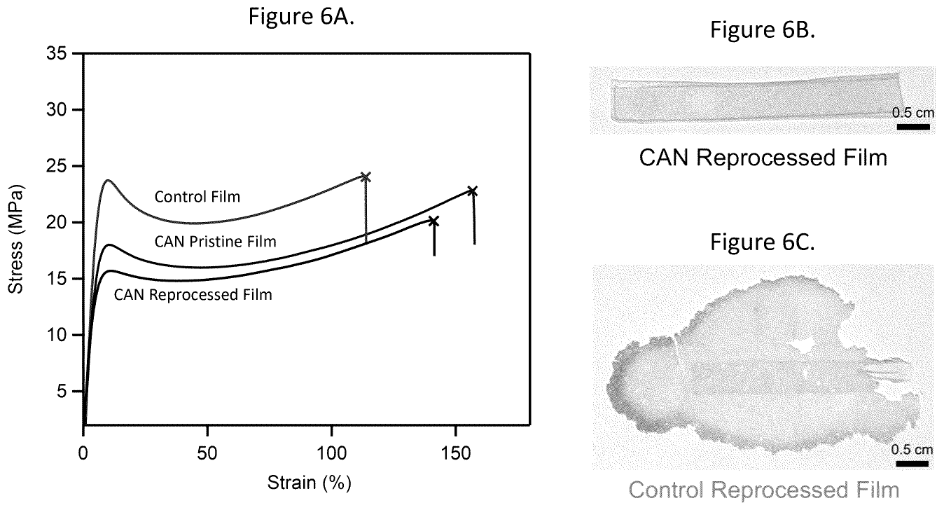

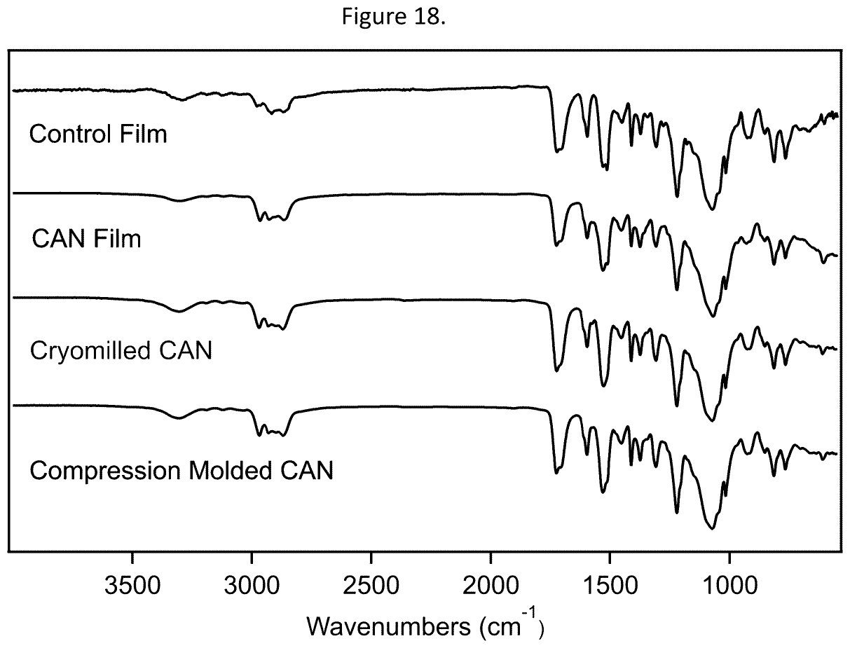

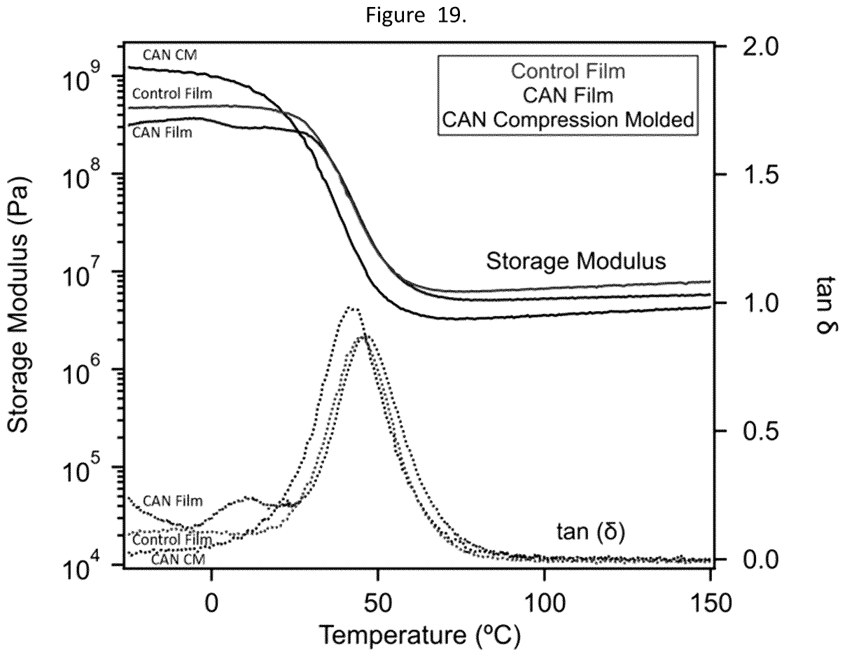

The dynamic nature of the CAN film allowed for traditional thermoset material reprocessing using compression molding. To obtain a homogenous sample, the films were milled at cryogenic temperatures, producing a fine powder that was chemically identical to the pristine CAN film (FIG. 18). This powder was compression molded at 150° C. under 10 tons of ram force for 1 hour, resulting in homogenous films with near-identical chemical and network properties to the pristine CAN film, as determined by FT-IR and DMTA (FIG. 6B, FIG. 18, FIG. 19, Table 2). Applying the same method to the control film did not produce a measurable sample (FIG. 6C). Since the CAN film displayed a small beta transition in DMTA that was absent in the control film, slight differences in their mechanical properties are expected when measured in the glassy state (FIG. 2C, FIG. 6A). When compared to the pristine CAN film, which had an average peak stress of 22 MPa and average peak strain of 148%, the reprocessed CAN film experienced slightly lower peak stress and peak strain of 18 MPa and 119% respectively (FIG. 6A, Table 1). As a result, the Young's modulus slightly increases from 15.0 to 15.8 MPa after reprocessing, reflecting a slight increase in stiffness (Table 1). While these average values for the reprocessed film vary slightly from the pristine film, they agree within the uncertainty of each measurement (Table 1). Small deviations in mechanical properties are likely to arise due to changes of morphology or crosslinks in the random networks.^{22, 37} Overall, the adhesive CAN films service life can be greatly extended by reprocessing and remolding material to fit application needs without sacrificing adhesive and mechanical properties.

TABLE 1
Mechanical properties of control film, pristine
CAN film, and reprocessed CAN film.

| | Average | Average | Average | |
|---|---|---|---|---|
| | Peak | Peak | Young's | Average |
| | Stress | Strain | Modulus | Toughness |
| Sample | (MPa) | (%) | (MPa) | (MPa) |
| Control | 24.25 ± 1.10 | 112.80 ± 21.04 | 21.94 ± 3.12 | 2333 ± 464 |
| CAN | 22.11 ± 2.42 | 148.08 ± 23.25 | 15.03 ± 0.98 | 2632 ± 507 |
| CAN | 18.58 ± 1.12 | 118.86 ± 15.41 | 15.75 ± 1.13 | 1887 ± 280 |
| Reprocessed | | | | |

### CONCLUSIONS

In this work, we demonstrated the utility of PU CANs beyond reprocessability for the application of self-healing adhesives. Dynamic urethane bonds, facilitated by a carbamate exchange catalysts, such as Zr(tmhd)₄, allowed the PU CAN to retain its adhesive strength over five healing cycles. Additionally, internal dynamic crosslinks in the CAN film permitted reprocessing using compression molding with no significant decrease in mechanical properties. Since PU CANs are highly tunable, this platform can be extended to a wide range of adhesive applications from construction to automotive to household environments.³ Monomer structure can be varied for desired properties and curing a 2-part system directly on the adherends may impart additional strength. Moreover, many different adherends can be activated for use with PU CANs by exposing surface functional groups, such as hydroxyl groups, through simple means such as oxygen plasma etching. Since covalent bonding of the adhesive to the substrate is reversible, valuable parts such as composites may be recovered at the end of their lifetime by simply removing the adhesive using heat, allowing for reprocessing and reuse. This work helps to bring PU CANs closer to implementation at industrial scales to improve polymer economy circularity.

### A. Materials and Instrumentation

Materials. All reagents were purchased from Sigma-Aldrich or Fisher Scientific. Polyols were dried in a vacuum oven at 90° C. under 20 mTorr vacuum for 16 hours prior to film synthesis. All other reagents were used without further purification unless otherwise specified. Dichloromethane (DCM) and toluene were purchased from Sigma-Aldrich and dried using a custom-built solvent purification system (JC Myer System) with an alumina column. Borosilicate glass sheets (25.4 mm (W)×3.175 mm (T)×76.2 mm (L)) were purchased from McMaster-Carr and cleaned with acetone prior to use. Commercial polyurethane adhesive GORILLA GLUE® (ASIN B01MDS317O) was purchased from Amazon.

Instrumentation. Infrared spectra were recorded on a ThermoFisher Nicolet iS20 with a ZnSe Smart iTR attachment. Spectra were uncorrected and normalized.

Dynamic mechanical thermal analysis (DMTA) was conducted on a TA Instruments RSA-G2 Solids Analyzer. Film samples were cut into rectangles (ca. 7 mm (W)×1.5 mm (T)×20 mm (L) and a gauge length of 10 mm) prior to analysis. The tension axial force was tared to 0 N and a strain adjustment was set to 30.0%, with a maximum strain of 10.0%, a minimum strain of 0.05%, maximum oscillation force of 0.01 N and maximum oscillation force of 0.2 N. A temperature sweep was conducted from −30° C. to 150° C. with a ramp rate of 5.0° C./min, with an oscillating strain of 0.05% and an angular frequency of 6.28 rad s⁻¹ (1 Hz).

Stress relaxation analysis was performed on a TA Instruments RSA-G2 Solids Analyzer using rectangular films (ca. 7 mm (W)×1.5 mm (T)×20 mm (L) and a gauge length of 10 mm). A strain adjustment of 30.0% was set with a maximum strain of 10.0%, a minimum strain of 0.05%, maximum oscillation force of 0.01 N and maximum oscillation force of 0.2 N. The sample was equilibrated at 160° C. for 120 s, then a strain of 5.0% was applied. While applying the constant 5.0% strain, 6.0 points were sampled per second until the sample had completely relaxed stress (roughly 30 minutes). Reported values are expressed as averages with standard deviation of at least three replicates.

For reprocessing, samples were milled at cryogenic temperatures using a RETSCH CryoMill. Samples were milled for two cryogenic cycles with automatic cooling. After the system was cooled, approximately 6 minutes at a frequency of 5 Hz, the grinding time was set to 4 minutes at 30 Hz. This was repeated a second time, with an intermediate cooling time of 30 seconds at 5 Hz. The resulting polymer powder was then placed in a mold between two steel plates and pressed using a preheated PHI 30-ton Manual Hydraulic Compression Press. Samples were compression molded for 1 hour at 150° C. under 10 tons of pressure. The sample was removed from the mold either cut into rectangles or dog bone shaped tensile bars.

Tensile testing was performed using an MTS Criterion Universal Test System with a 2.5 kN load cell following ASTM D-1708. Film samples were cut into dog bone shaped bars (ca. 5 mm (W)×2 mm (T)×25 mm (L) and a gauge length of 16 mm) using a die-press. Samples were pulled at a uniaxial extension rate of 0.5 mm/s at ambient temperature. Young's Modulus was calculated from the peak stress and peak strain. Toughness was calculated by integrating the stress strain curve. All values are reported as averages and standard deviation of at least five replicates.

Differential Scanning calorimeter under a nitrogen atmosphere. Samples (5-10 mg) were heated to 120.00° C. at a rate of 10.00° C./min to erase thermal history. The samples were then cooled to −30.00° C. at 10.00° C./min, then heated to 150.00° C. Displayed differential thermograms are from the second heating ramp. The glass transition temperature (T_{g}) was calculated from the maximum value of the derivative of heat flow with respect to temperature.

Lap shear testing was performed using a MTS Criterion Universal Test System with a 2.5 kN load cell following ASTM D-1002-10. Samples were cut into rectangles (ca. 25.4 mm (W)×1.5 mm (T)×12.7 mm (L)) using shears and borosilicate glass substrates (25.4 mm (W)×3.175 mm (T)×76.2 mm (L) unless otherwise noted) were cleaned with acetone. Metal binder clips were used to clamp samples between two glass substrates with a joint overlap area of 25.4 mm (W)×12.7 mm (L). Spacers identical to the thickness of the sample film were used to ensure substrate alignment. Samples were cured at 150° C. for two hours. To prepare the commercial PU adhesive lap shear samples, glass substrates were first cleaned with acetone, then the joint overlap area was wetted with water. A thin layer of Gorilla Glue® was spread in the overlap area and the substrates were clamped together and cured at room temperature for 24 hours. Lap shear testing was conducted using offset grips and samples were pulled at a rate of 0.05 in/min with a data acquisition rate of 5.0 Hz. Average lap shear strength was calculated using the load at failure and adhesive joint area. Average lap shear strength values represent the average of at least three replicates, including samples with a lap shear strength of zero, which broke prior to measurement. Error bars represent the standard deviation of the measurable samples. The samples tested in FIG. 7 and FIG. 16 were not measured in triplicate, values are reported for a single measurement. After initial lap shear testing, all free substrates were cleaned with acetone. The lap shear samples were then healed by clamping together with metal binder clips and appropriate spacers and cured for 2 hours at 150° C. This process was repeated for five healing cycles. Statistical analysis was performed using a one-tailed T-test with unequal variance to determine significance levels. The recovery ratio was calculated based on the average lap shear strength with respect to the previous cycle's average lap shear strength. The recovery ratios for all healing cycles were then averaged. For silanization, the glass substrates were soaked in a solution of 5% (v/v %) of dichlorodimethylsilane in dry toluene for 30 minutes. The substrates were rinsed three times with dry toluene, then rinsed three times with dry methanol, and dried overnight at 150° C. prior to lap shear sample preparation as described above. A set of glass substrates was cleaned under O₂ plasma (Harrick Plasma) for 5 minutes at 10.5 W radiofrequency power with a pressure of around 200 mTorr, then lap shear samples were prepared as described above.

Thermogravimetric analysis (TGA) was performed on a TA Instruments TGA5500 using 15-20 mg of sample. Samples were heated under nitrogen atmosphere at a rate of 10.00° C./min from 25° C. to 500° C. For isothermal TGA, samples were heated under air and held at 150° C. for 16 hours. Buoyancy effect for air was corrected by measuring the empty crucible under the same measurement conditions used for the samples. Performance of the thermobalance of the STA was verified by using a certified sample of calcium oxalate monohydrate (European Pharmacopoeia Reference Standard) up to 1000° C.

### B. Synthetic Procedures

Synthesis of Crosslinked Polyurethane Adhesive CAN Films: Polyol components were dried under 20 mTorr vacuum at 90° C. for 16 hours prior to use. In a 40 mL scintillation vial, poly[trimethylolpropane/di(propylene glycol)-alt-adipic acid/phthalic anhydride], polyol (—OH equivalent 2.5, 1.00 g, 2.00 mmol), polypropylene glycol (1000 g/mol, 3.83 g, 3.83 mmol), pentaerythritol propoxylate (5/4 PO/OH, 426 g/mol, 1.50 g, 3.52 mmol), and zirconium tetrakis(2,2,6,6-tetramethyl-3,5-heptanedionate) (0.23 g, 0.28 mmol, 1 mol % wrt urethane) were dissolved in dry DCM by vortexing. To this solution, 4,4′-methylenebis(phenyl isocyanate) (3.45 g, 13.78 mmol) was added and sonicated and vortexed until complete dissolution. The solution was cast into an aluminum pan and cured at room temperature for 24 hours, then post-cured for 48 hours in a vacuum oven under 20 mTorr vacuum at 90° C.

### CAN Film:

FT-IR (solid, ATR) 3303 (N—H stretch), 2967 (sp³ C—H stretch), 2866 (sp³ C—H stretch), 1725 (C═O stretch), 1709 (C—O stretch), 1596, 1530 (N—H deformation), 1511 (N—H deformation), 1453, 1412, 1375, 1308, 1221, 1069 (C—N stretch), 1017, 930, 815, 767, 607 cm⁻¹.

Synthesis of Crosslinked Polyurethane Adhesive Control Films: Polyol components were dried under 20 mTorr vacuum at 90° C. for 16 hours prior to use. In a 40 mL scintillation vial, poly[trimethylolpropane/di(propylene glycol)-alt-adipic acid/phthalic anhydride], polyol (—OH equivalent 2.5, 1.00 g, 2.00 mmol), polypropylene glycol (1000 g/mol, 4.01 g, 4.01 mmol), and pentaerythritol propoxylate (5/4 PO/OH, 426 g/mol, 1.50 g, 3.52 mmol) were dissolved in dry toluene by vortexing. To this solution, 4,4′-methylenebis(phenyl isocyanate) (3.50 g, 13.96 mmol) was added. The solution was heated at 60° C. and vortexed until completely dissolved. The solution was then cast into an aluminum pan and cured at 60° C. for 18 hours, then 100° C. for 4 hours, then 140° C. for 2 hours, then post-cured for 16 hours in a vacuum oven under 20 mTorr vacuum at 90° C.

### Control Film:

FT-IR (solid, ATR) 3304 (N—H stretch), 2969 (sp³ C—H stretch), 2917 (sp³ C—H stretch), 2870 (sp³ C—H stretch), 1725 (C═O stretch), 1709 (C═O stretch), 1597, 1533 (N—H deformation), 1513 (N—H deformation), 1453, 1412, 1374, 1309, 1222, 1069 (C—N stretch), 1017, 928, 815, 768, 706, 611 cm⁻¹.

### C. Characterization Tables and Figures

TABLE 2
Network properties of CAN, compression
molded CAN, and control films.

| | T_{g} | Gel Fraction | Average M_{c} |
|---|---|---|---|
| Sample | (° C.)^{a} | (%)^{b} | (g/mol)^{c} |
| CAN | 23.4 | 96.8 ± 0.4 | 782 ± 133 |
| CAN Compression Molded | 22.8 | 96.4 ± 0.8 | 896 ± 95 |
| Control | 24.8 | 98.9 ± 0.2 | 525 ± 33 |

^{a}Glass transition temperature (T_{g}) determined from DSC,
^{b}gel fraction in DCM after 24 hours,
^{c}average molecular weight between crosslinks calculated using DMTA from the storage modulus (E′) at 100° C. and the film density. (Equation 1.)

$${M}_{c} = \frac{3 RTd}{{E}^{′}}$$

Equation 1. Derivation of molecular weight between crosslinks where R is the universal gas constant, T is temperature, d is film density, and E′ is the rubbery plateau storage modulus from DMTA.

TABLE 3
SRA results, control film does not relax
stress in a reasonable time scale.

| | | Average | Average | Average RS |
|---|---|---|---|---|
| Sample | Catalyst | τ* (s) | β | Maximum (s) |
| CAN Film | 1 mol % | 489 ± 42 | 0.85 ± 0.02 | 555 ± 153 |
| | Zr(tmhd)₄ | | | |
| Control Film | No Catalyst | N/A | N/A | N/A |

$$G ( t ) = {G}_{0} {e}^{- {( \frac{t}{τ} )}^{β}}$$

Equation 2. Stretched exponential function fit (or Kohlrausch-Williams-Watts (KWW) fit) applied to SRA data, where G(t) is the modulus with respect to time, Go is the initial modulus, τ is the characteristic stress relaxation time at which the modulus reaches 1/e of its initial value, and β is the stretching exponent and represents the dispersity of relaxation events.

$$G ( t ) = {G}_{e} + {\int }_{0}^{+ ∞} G ( τ ) * {e}^{( \frac{- t}{τ} )} d τ$$

Equation 3. Generalized maxwell model used to deconvolute SRA data into relaxation spectra (RS) based on the report by Kontogiorgos et al.³⁸ Where G(t) is the modulus with respect to time, Gₑ is the equilibrium modulus, τ is the characteristic stress relaxation time at which the modulus reaches 1/e of its initial value, G(τ) is the distribution function of relaxation times and was generated over t ranging from 10⁻⁴ to 10⁸ s. RS analysis was conducted using a MATLAB code developed in house based on similar analysis described by Zhang et. al.³⁹ Using Hansen's algorithms, an L-curve method was used to determine the regularization parameter and a Tikhonov regularization method was used to calculate the relaxation spectrum.⁴⁰

TABLE 4
SRA values obtained from stretched exponential (KWW)
fit analysis and relaxation spectra global maxima.

| Sample # | τ* (s) | β | KWW R² | RS Maximum (s) |
|---|---|---|---|---|
| 1 | 446 | 0.85 | 0.9996 | 408 |
| 2 | 530 | 0.86 | 0.9996 | 544 |
| 3 | 492 | 0.83 | 0.9992 | 713 |
| Average | 489 ± 42 | 0.85 ± 0.02 | 0.9995 | 555 ± 153 |

### REFERENCES

(1) Structural Adhesives Chemistry and Technology; Springer, 2012. DOI: 10.1007/978-1-4684-7781-8.
(2) Burchardt, B. 3-Advances in polyurethane structural adhesives. In Advances in Structural Adhesive Bonding, Dillard, D. A. Ed.; Woodhead Publishing, 2010; pp 35-65.
(3) A. Pizzi., K. L. M. Handbook of Adhesive Technology; 2003.
(4) Bishopp, J. A.; Davies, L.; Haslam, J. J. Chemical and mechanical characterization of adhesive matrices. Int. J. Adhes. Adhes. 1993, 13 (2), 111-119. DOI: 10.1016/0143-7496(93) 90022-2.
(5) Osman, M. A.; Mittal, V.; Morbidelli, M.; Suter, U. W. Polyurethane Adhesive Nanocomposites as Gas Permeation Barrier. Macromolecules 2003, 36 (26), 9851-9858. DOI: 10.1021/ma035077x.
(6) Li, Z.; Zhang, R.; Moon, K.-S.; Liu, Y.; Hansen, K.; Le, T.; Wong, C. P. Highly Conductive, Flexible, Polyurethane-Based Adhesives for Flexible and Printed Electronics. Adv. Funct. Mater. 2013, 23 (11), 1459-1465. DOI: 10.1002/adfm.201202249.
(7) Leitsch, E. K.; Heath, W. H.; Torkelson, J. M. Polyurethane/polyhydroxyurethane hybrid polymers and their applications as adhesive bonding agents. Int. J. Adhes. Adhes. 2016, 64, 1-8. DOI: 10.1016/j.ijadhadh.2015.09.001.
(8) Faneco, T. M. S.; Campilho, R. D. S. G.; Silva, F. J. G.; Lopes, R. M. Strength and Fracture Characterization of a Novel Polyurethane Adhesive for the Automotive Industry. J. Test. Eval. 2017, 45 (2), 398-407. DOI: 10.1520/JTE20150335.
(9) Yang, Y.; Du, F.-S.; Li, Z.-C. Highly Stretchable, Self-Healable, and Adhesive Polyurethane Elastomers Based on Boronic Ester Bonds. ACS Appl. Polym. Mater. 2020, 2 (12), 5630-5640. DOI: 10.1021/acsapm.0c00941.
(10) Szycher, M. Szycher's Handbook of Polyurethanes. J. Am. Chem. Soc. 2000, 122 (16), 3983-3983. DOI: 10.1021/ja004704k.
(11) Wang, S.; Liu, Z.; Zhang, L.; Guo, Y.; Song, J.; Lou, J.; Guan, Q.; He, C.; You, Z. Strong, detachable, and self-healing dynamic crosslinked hot melt polyurethane adhesive. Mater. Chem. Front. 2019, 3 (9), 1833-1839. DOI: 10.1039/C9QM00233B.
(12) Bowman, C.; Du Prez, F.; Kalow, J. Introduction to chemistry for covalent adaptable networks. Polym. Chem. 2020, 11 (33), 5295-5296. DOI: 10.1039/DOPY90102D.
(13) Zhang, Y.; Zhang, L.; Yang, G.; Yao, Y.; Wei, X.; Pan, T.; Wu, J.; Tian, M.; Yin, P. Recent advances in recyclable thermosets and thermoset composites based on covalent adaptable networks. J. Mater. Sci. Technol. 2021, 92, 75-87. DOI: 10.1016/j.jmst.2021.03.043.
(14) Kloxin, C. J.; Bowman, C. N. Covalent adaptable networks: smart, reconfigurable and responsive network systems. Chem. Soc. Rev. 2013, 42 (17), 7161-7173. DOI: 10.1039/C3CS60046G.
(15) Cui, C.; Chen, X.; Ma, L.; Zhong, Q.; Li, Z.; Mariappan, A.; Zhang, Q.; Cheng, Y.; He, G.; Chen, X.; et al. Polythiourethane Covalent Adaptable Networks for Strong and Reworkable Adhesives and Fully Recyclable Carbon Fiber-Reinforced Composites. ACS Appl. Mater. Interfaces 2020, 12 (42), 47975-47983. DOI: 10.1021/acsami.0c14189.
(16) Li, L.; Chen, X.; Torkelson, J. M. Covalent Adaptive Networks for Enhanced Adhesion: Exploiting Disulfide Dynamic Chemistry and Annealing during Application. ACS Appl. Polym. Mater. 2020, 2 (11), 4658-4665. DOI: 10.1021/acsapm.0c00720.
(17) Yang, S.; Bai, J.; Sun, X.; Zhang, J. Robust and healable poly(disulfides) supramolecular adhesives enabled by dynamic covalent adaptable networks and noncovalent hydrogen-bonding interactions. Chem. Eng. J. 2023, 461, 142066. DOI: 10.1016/j.cej.2023.142066.
(18) Rahman, M. A.; Bowland, C.; Ge, S.; Acharya, S. R.; Kim, S.; Cooper, V. R.; Chen, X. C.; Irle, S.; Sokolov, A. P.; Savara, A.; et al. Design of tough adhesive from commodity thermoplastics through dynamic crosslinking. Sci. Adv. 2021, 7 (42), eabk2451. DOI: 10.1126/sciadv.abk2451.
(19) Yan, Q.; Zhou, M.; Fu, H. A reversible and highly conductive adhesive: towards self-healing and recyclable flexible electronics. J. Mater. Chem. C 2020, 8 (23), 7772-7785. DOI: 10.1039/C9TC06765E.
(20) Chazovachii, P. T.; Somers, M. J.; Robo, M. T.; Collias, D. I.; James, M. I.; Marsh, E. N. G.; Zimmerman, P. M.; Alfaro, J. F.; McNeil, A. J. Giving superabsorbent polymers a second life as pressure-sensitive adhesives. Nat. Commun. 2021, 12 (1), 4524. DOI: 10.1038/s41467-021-24488-9.
(21) Zhao, X.-L.; Li, Y.-D.; Weng, Y.; Zeng, J.-B. Biobased epoxy covalent adaptable networks for high-performance recoverable adhesives. Ind. Crops. Prod. 2023, 192, 116016. DOI: 10.1016/j.indcrop.2022.116016.
(22) Putnam-Neeb, A. A.; Stafford, A.; Babu, S.; Chapman, S. J.; Hemmingsen, C. M.; Islam, M. S.; Roy, A. K.; Kalow, J. A.; Varshney, V.; Nepal, D.; et al. Oligosiloxane-Based Epoxy Vitrimers: Adaptable Thermosetting Networks with Dual Dynamic Bonds. ACS Appl. Polym. Mater. 2024. DOI: 10.1021/acsapm.3c03082.
(23) Montarnal, D.; Capelot, M.; Tournilhac, F.; Leibler, L. Silica-Like Malleable Materials from Permanent Organic Networks. Science 2011, 334 (6058), 965-968. DOI: 10.1126/science.1212648.
(24) Yue, L.; Guo, H.; Kennedy, A.; Patel, A.; Gong, X.; Ju, T.; Gray, T.; Manas-Zloczower, I. Vitrimerization: Converting Thermoset Polymers into Vitrimers. ACS Macro Lett. 2020, 9 (6), 836-842. DOI: 10.1021/acsmacrolett.0c00299.
(25) Li, X.; Qiu, X.; Yang, X.; Zhou, P.; Guo, Q.; Zhang, X. Multi-Modal Melt-Processing of Birefringent Cellulosic Materials for Eco-Friendly Anti-Counterfeiting. Adv. Mater. 2024, n/a (n/a), 2407170. DOI: 10.1002/adma.202407170.
(26) Liang, C.; Gracida-Alvarez, U. R.; Gallant, E. T.; Gillis, P. A.; Marques, Y. A.; Abramo, G. P.; Hawkins, T. R.; Dunn, J. B. Material Flows of Polyurethane in the United States. Environ. Sci. Technol. 2021, 55 (20), 14215-14224. DOI: 10.1021/acs.est.1c03654.
(27) OECD. Global Plastics Outlook; 2022. https://www.oecd-ilibrary.org/content/publication/aa1edf33-en DOI: 10.1787/aa1edf33-en.
(28) Sheppard, D. T.; Jin, K.; Hamachi, L. S.; Dean, W.; Fortman, D. J.; Ellison, C. J.; Dichtel, W. R. Reprocessing Postconsumer Polyurethane Foam Using Carbamate Exchange Catalysis and Twin-Screw Extrusion. ACS Cent. Sci. 2020, 6 (6), 921-927. DOI: 10.1021/acscentsci.0c00083.
(29) Fortman, D. J.; Sheppard, D. T.; Dichtel, W. R. Reprocessing Cross-Linked Polyurethanes by Catalyzing Carbamate Exchange. Macromolecules 2019, 52 (16), 6330-6335. DOI: 10.1021/acs.macromol.9b01134.
(30) Swartz, J. L.; Elling, B. R.; Castano, I.; Thompson, M. P.; Sheppard, D. T.; Gianneschi, N. C.; Dichtel, W. R. Copolymers Prepared by Exchange Reactions Enhance the Properties of Miscible Polymer Blends. Macromolecules 2022, 55 (19), 8548-8555. DOI: 10.1021/acs.macromol.2c01268.
(31) Ferraz da Silva, I.; Freitas-Lima, L. C.; Graceli, J. B.; Rodrigues, L. C. M. Organotins in Neuronal Damage, Brain Function, and Behavior: A Short Review. (1664-2392 (Print)). DOI: 10.3389/fendo.2017.00366 From 2017.
(32) Sun, M.; Sheppard, D. T.; Brutman, J. P.; Alsbaiee, A.; Dichtel, W. R. Green Catalysts for Reprocessing Thermoset Polyurethanes. Macromolecules 2023, 56 (17), 6978-6987. DOI: 10.1021/acs.macromol.3c01116.
(33) Kim, S.; Swartz, J. L.; Sala, O.; Sun, M.; Oanta, A. K.; Brutman, J. P.; Alsbaiee, A.; Dichtel, W. R. Thermal Activation of Zirconium (IV) Acetylacetonate Catalysts to Enhance Polyurethane Synthesis and Reprocessing. Macromolecules 2024, 57 (14), 6759-6768. DOI: 10.1021/acs.macromol.4c00625.
(34) Chen, Z.; Sun, Y.-C.; Wang, J.; Qi, H. J.; Wang, T.; Naguib, H. E. Flexible, Reconfigurable, and Self-Healing TPU/Vitrimer Polymer Blend with Copolymerization Triggered by Bond Exchange Reaction. ACS Appl. Mater. Interfaces 2020, 12 (7), 8740-8750. DOI: 10.1021/acsami.9b21411.
(35) Farzaneh, S.; Fitoussi, J.; Lucas, A.; Bocquet, M.; Tcharkhtchi, A. Shape memory effect and properties memory effect of polyurethane. J. Appl. Polym. Sci. 2013, 128 (5), 3240-3249. DOI: 10.1002/app.38530.
(36) Delebecq, E.; Pascault, J.-P.; Boutevin, B.; Ganachaud, F. On the Versatility of Urethane/Urea Bonds: Reversibility, Blocked Isocyanate, and Non-isocyanate Polyurethane. Chem. Rev. 2013, 113 (1), 80-118. DOI: 10.1021/cr300195n.
(37) Peterson, G. I.; Ko, W.; Hwang, Y.-J.; Choi, T.-L. Mechanochemical Degradation of Amorphous Polymers with Ball-Mill Grinding: Influence of the Glass Transition Temperature. Macromolecules 2020, 53 (18), 7795-7802. DOI: 10.1021/acs.macromol.0c01510
(38) Kontogiorgos, V.; Jiang, B.; Kasapis, S. Numerical computation of relaxation spectra from mechanical measurements in biopolymers. Food Res. Int. 2009, 42 (1), 130-136. DOI: 10.1016/j.foodres.2008.09.005.
(39) Zhang, H.; Van Hertrooij, A.; Schnitzer, T.; Chen, Y.; Majumdar, S.; Van Benthem, R. A. T. M.; Sijbesma, R. P.; Heuts, J. P. A. Benzene Tetraamide: A Covalent Supramolecular Dual Motif in Dynamic Covalent Polymer Networks. Macromolecules 2023, 56 (16), 6452-6460. DOI: 10.1021/acs.macromol.3c01083.
(40) Hansen, P. C. REGULARIZATION TOOLS: A Matlab package for analysis and solution of discrete ill-posed problems. Numer. Algorithms 1994, 6, 1-35.

We claim:

1. An article comprising an adherend and a polyurethane adhesive comprising a carbamate exchange catalyst adhered thereon, wherein the polyurethane adhesive is configured to retain adhesive strength over one or more healing cycles.

2. The article of claim 1, wherein retaining adhesive strength over one or more healing cycles is an average strength recovery ratio of at least 80% per healing cycle.

3. The article of claim 1, wherein the polyurethane adhesive retains adhesive strength over five or more healing cycles.

4. The article of claim 1, wherein the polyurethane adhesive is adhered to the adherend with a covalent bond.

5. The article of claim 4, wherein the covalent bond is reversible.

6. The article of claim 1, wherein the adherend comprises functional groups capable of reversible bonding with the polyurethane adhesive.

7. The article of claim 1, wherein the adherend comprises exposed surface hydroxyl groups.

8. The article of claim 1, wherein the carbamate exchange catalyst is zirconium tetrakis(2,2,6,6-tetramethyl-3,5-heptanedionate).

9. A method comprising healing the polyurethane adhesive after a load has been applied to the polyurethane adhesive of the article according to claim 1.

10. The method of claim 9, wherein the polyurethane adhesive is healed after adhesive failure.

11. The method of claim 9, wherein the polyurethane adhesive is healed prior to adhesive failure.

12. The method of claim 9, wherein healing the polyurethane adhesive comprises heating the polyurethane adhesive to a carbamate exchange temperature between 110° C. and 220° C. and/or mechanically processing the polyurethane adhesive and/or wherein the polyurethane adhesive is heated to the carbamate exchange temperature for carbamate exchange time between 30 minutes and 4 hours.

13. The method of claim 9, wherein retaining adhesive strength over one or more healing cycles is an average strength recovery ratio of at least 80% per healing cycle.

14. A method comprising applying a polyurethane adhesive comprising a carbamate exchange catalyst to an adherend, wherein the polyurethane adhesive is configured to retain adhesive strength over one of more healing cycles.

15. The method of claim 14, wherein applying the polyurethane adhesive to the adherend comprises forming a covalent bond between the polyurethane adhesive and the adherend.

16. The method of claim 15, wherein the covalent bond is formed by heating the polyurethane adhesive to a carbamate exchange temperature between 110° C. and 220° C. and/or mechanically processing the polyurethane adhesive and/or wherein the polyurethane adhesive is heated to the carbamate exchange temperature for carbamate exchange time between 30 minutes and 4 hours.

17. The method of claim 15, covalent bond is reversible.

18. The method of claim 14, wherein the adherend comprises functional groups capable of reversible bonding with the polyurethane adhesive.

19. The method of claim 14, wherein the adherend comprises exposed surface hydroxyl groups.

20. The method of claim 14 further comprising healing the polyurethane adhesive after a load has been applied to the polyurethane adhesive.
